(19) United States
(12) Patent Application Publication
(10) Pub. No.: US 2013/0326242 A1
(43) Pub. Date: Dec. 5, 2013

(54) POWER SUPPLY APPARATUS FOR DATACENTER

(71) Applicant: HON HAI PRECISION INDUSTRY CO., LTD., New Taipei (TW)

(72) Inventor: FENG-CHI YANG, New Taipei (TW)

(73) Assignee: HON HAI PRECISION INDUSTRY CO., LTD., New Taipei (TW)

(21) Appl. No.: 13/902,894

(22) Filed: May 27, 2013

(30) Foreign Application Priority Data
May 31, 2012 (CN) 2012101761994

(51) Int. Cl. G06F 1/26

(52) U.S. Cl. CPC G06F 1/26
USPC 713/300

(57) ABSTRACT

A power supply apparatus for a datacenter includes a carrier to carry the datacenter on rails of a rail transport system, a number of pantographs each including a main body with first and second terminals and a contact plate connected to the first terminal of the main body, and a number of power supply systems. The contact plate of each pantograph is electrically in contact with a cable of the rail transport system. The power supply systems are coupled to the second terminals of the pantographs, and each of the power supply systems acquires power from the cable through the corresponding pantograph, and provides power for the datacenter.

### BACKGROUND

1. Technical Field

The present disclosure relates to a power supply apparatus for a datacenter.

2. Description of Related Art

A container datacenter may consist of one or more servers, a power supply system providing power for the servers, and a cooling system for dissipating heat generated by the servers. Although the container datacenter may be ready to operate, it cannot be powered up until it has been transported to a destination and connected to a power source.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic view of an embodiment of a power supply apparatus for a datacenter of the present disclosure, wherein the power supply apparatus includes a first power supply system.

FIG. 2 is a block diagram of the first power supply system of FIG. 1.

FIG. 3 is similar to FIG. 1, but shows a state of use.

### DETAILED DESCRIPTION

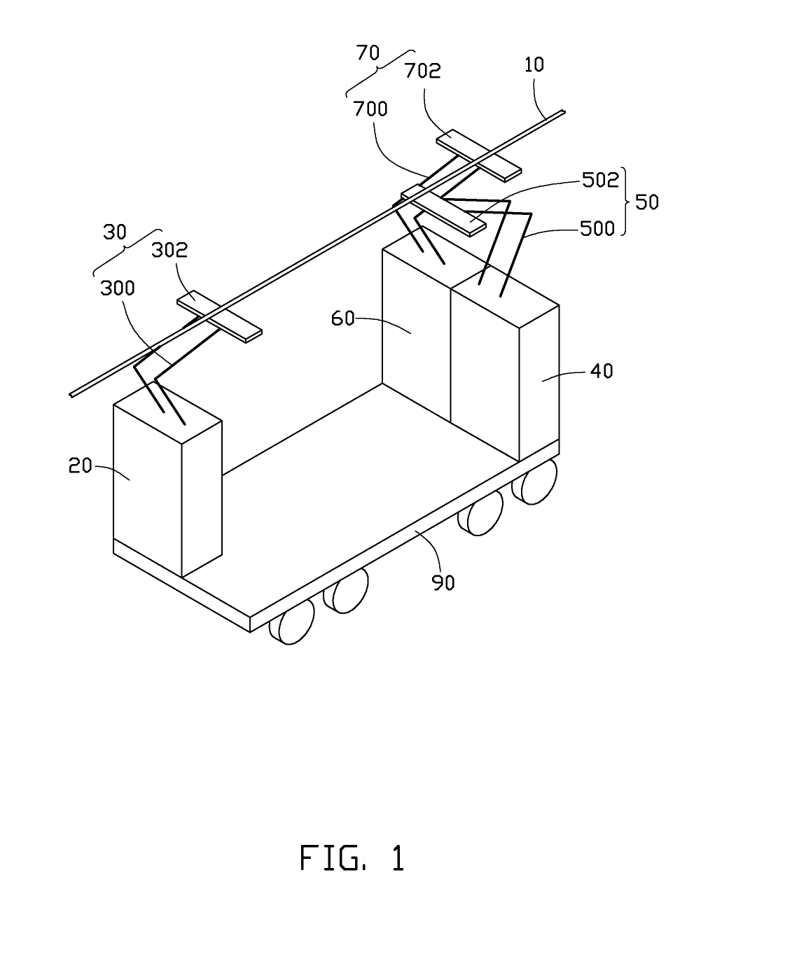

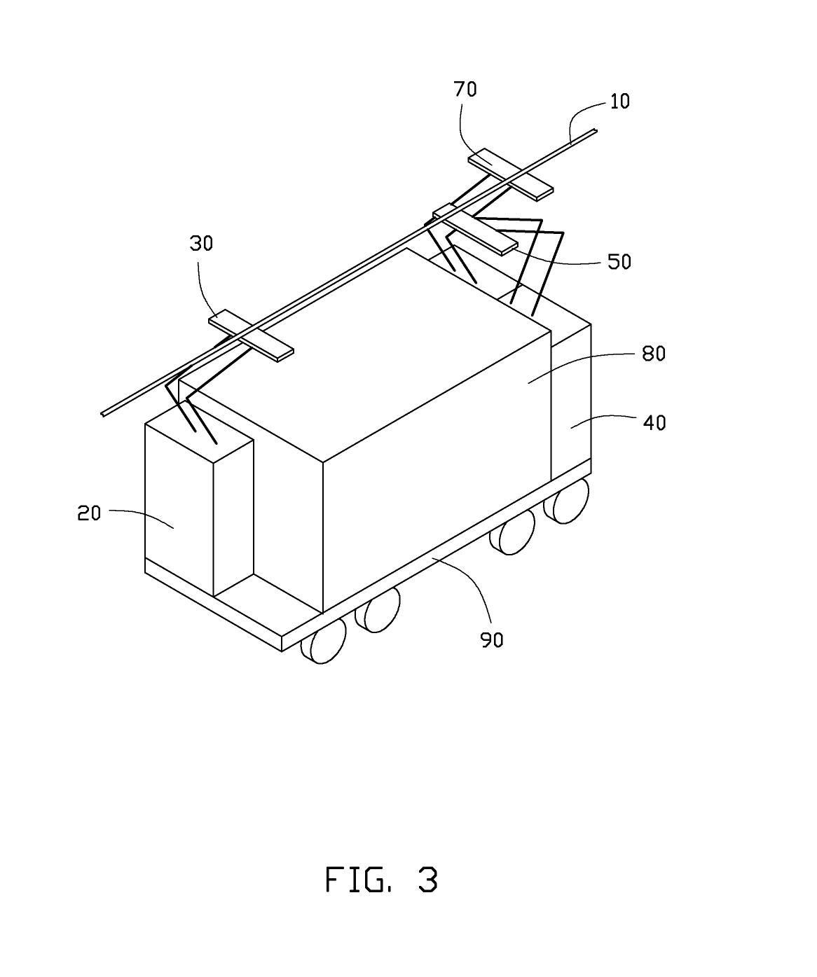

When a datacenter is being transported by electric train, the present disclosure provides for tapping into the same power as is used to power the train. FIG. 1 illustrates an embodiment of a power supply apparatus of the present disclosure. The power supply apparatus acquires power from a cable 10 connected to a power grid of a rail transport system, and provides power for a datacenter 80 (shown in FIG. 3). The power supply apparatus includes a carrier 90, a plurality of power supply systems, and a plurality of pantographs connected to the power supply systems and electrically contacting the cable 10.

In the illustrated embodiment, the power supply systems include a first power supply system 20, a second power supply system 40, and a third power supply system 60. The pantographs includes a first pantograph 30 coupled to the first power supply system 20, a second pantograph 50 coupled to the second power supply system 40, and a third pantograph 70 coupled to the third power supply system 60. In other embodiments, each power supply system may be coupled to more than one pantograph.

Each of the first to third pantographs 30, 50, and 70 includes a main body with first and second terminals and a contact plate electrically connected to the first terminal of the main body. For example, the first pantograph 30 includes a main body 300 and a contact plate 302 electrically contacting the first terminal of the main body 300 to the cable 10. The second pantograph 50 includes a main body 500 and a contact plate 502 electrically contacting the first terminal of the main body 500 to the cable 10. The third pantograph 70 includes a main body 700 and a contact plate 702 electrically contacting the first terminal of the main body 700 to the cable 10. The contact plates 302, 502, and 702, and the main bodies 300, 500, and 700 are made of conductive material. In the illustrated embodiment, the main bodies 300, 500, and 700 are substantially V-shaped, the contact plates 302, 502, and 702 are substantially rectangular with top surfaces electrically contacting the cable 10 and bottom surfaces connected to the first terminals of the corresponding main bodies. The pantographs slidably press the contact plates against the cable 10 to establish electrical contact.

The carrier 90 can be moved on rails of the rail transport system as part of a train.

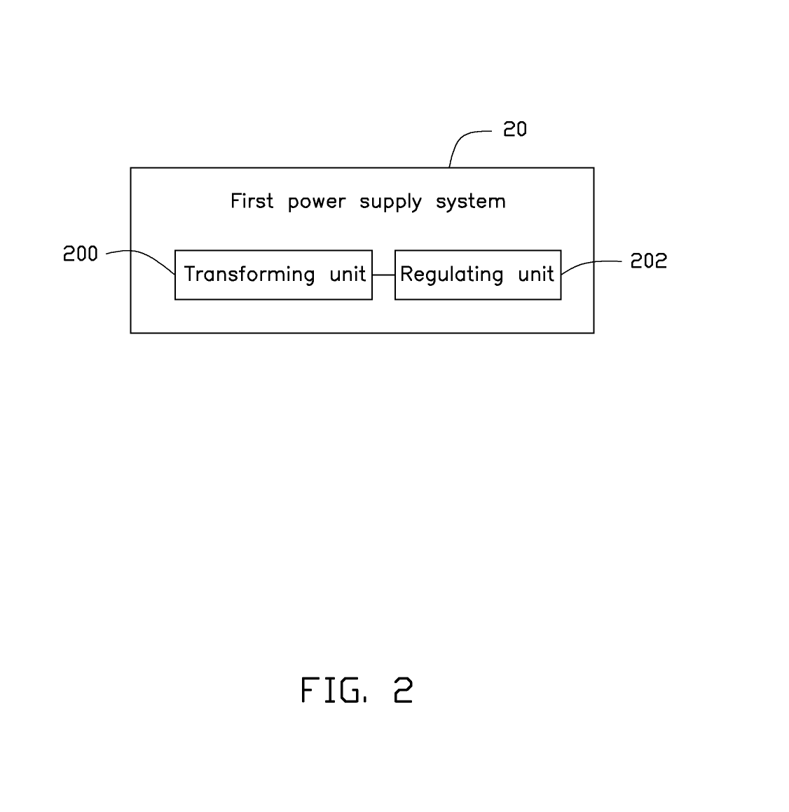

FIG. 2 illustrates that each of the first to third power supply system 20, 40, and 60 includes a transforming unit and a regulating unit. For example, the first power supply system 20 includes a transforming unit 200 and a regulating unit 202. The transforming unit of each power supply system is coupled to the second terminal of the main body that the power supply system is connected to, to acquire power from the cable 10 through the corresponding main body. For example, the transforming unit 200 of the first power supply system 20 is coupled to the second terminal of the main body 300 of the first pantograph 30. The transforming unit of the second power supply system 40 is coupled to the second terminal of the main body 500 of the second pantograph 50. The transforming unit of the third power supply system 60 is coupled to the second terminal of the main body 700 of the third pantograph 70. The transforming units are configured to transform the power from the cable 10, and output transformed power to the corresponding regulating units. The regulating units are configured to regulate the transformed power and provide power to servers in the datacenter 80. In one embodiment, the second and third power supply systems 40 and 60 are employed to provide power for the datacenter 80, and the first power supply system 20 is redundant. If one of the second and the third power supply systems 40 and 60 malfunctions, the first power supply system 20 can be employed to take its place and provide power for the datacenter 80.

FIG. 3 illustrates that the first power supply system 20 is arranged at a first end of the carrier 90, the second and third power supply systems 40 and 60 are arranged at a second end of the carrier 90 opposite to the first end, and the datacenter 80 is arranged between the first power supply system 20 and the second and third power supply systems 40 and 60. In other embodiments, the first to third power supply systems 20, 40, and 60 can be arranged elsewhere on the datacenter 80.

When the datacenter 80 needs to be transported, the datacenter 80 is loaded on the carrier 90, and then is transported to the destination by the train. During transport, the first to third power supply systems 20, 40, and 60 can acquire power from the cable 10 of the rail transport system through the first to third pantographs 30, 50, and 70, to provide power for the datacenter 80. Accordingly, the datacenter 80 can operate normally during transport.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power supply apparatus for a datacenter, comprising:
a carrier supporting the datacenter and arranged on rails of a rail transport system;
a plurality of pantographs each comprising a main body with first and second terminals and a contact plate connected to the first terminal of the main body, wherein the contact plate of each pantograph is contacting the first terminal to a cable of the rail transport system to establish electrical contact; and
a plurality of power supply systems coupled to the second terminals of the pantographs, respectively, wherein each of the plurality of power supply systems acquires power from the cable through the corresponding pantographs, and provides power for the datacenter.

2. The power supply apparatus of claim 1, wherein each power supply system comprises a transforming unit and a regulating unit coupled to the transforming unit, the transforming unit is configured to transform the power from the cable and output transformed power to the regulating unit, the regulating unit is configured to regulate the transformed power and provide regulated power for the datacenter.

3. The power supply apparatus of claim 2, wherein the main body of each pantograph is substantially V-shaped.
